(19) United States
(12) Patent Application Publication
(10) Pub. No.: US 2004/0228282 A1
(43) Pub. Date: Nov. 18, 2004

(54) Method and apparatus for determining a quality measure of a channel within a communication system

(76) Inventors: Qi Bao, Norwood, MA (US); Whay C. Lee, Cambridge, MA (US)

Correspondence Address: KENNETH A. HAAS, Motorola, Inc.-Law Department, Law Department, Schaumburg, IL, 60196, US

(21) Appl. No.: 10/439,788

(22) Filed: May 16, 2003

(51) Int. Cl. H04L 12/26

(52) U.S. Cl. 370/252

(57) ABSTRACT

A bandwidth manager sets a target packet loss probability under the assumption that the channel is perfect. A real-time estimation of an effective probability of packet loss caused by collisions (referred to as load-specific packet loss probability) is then determined by filtering out statistics relating to packet loss probability that exceeds the target packet loss probability. The probability of packet loss caused by channel impairments (referred to as impairment-specific packet loss probability) is computed after the estimates of both the load-specific packet loss probability and an overall packet loss probability is estimated. The channel quality is then estimated in terms of the impairment-specific packet loss probability by considering the overhead due to retransmissions of lost packets caused by channel impairments.

### FIELD OF THE INVENTION

The present invention relates generally to communication systems with collision channels that are subject to time-varying impairments, and in particular, to a method and apparatus for determining a quality measure of a channel in such communication systems.

### BACKGROUND OF THE INVENTION

There is an increasing need to provide quality of service (QoS) support in systems that transmit information, in the form of data units known as packets or frames, over channels that are subject to time-varying impairments. Examples of such systems include wireless local area networks (LANS) and power line LANS. Since many QoS requirements directly relate to channel quality, it is necessary to estimate the state of such channels to enable mitigation of any negative impacts caused by degradations. One particular problem that exists in a communication system that provides QoS is the problem of estimating a channel quality measure at a medium access control (MAC) layer, wherein the MAC layer employs a contention-based protocol (i.e., one that allows packet collisions to occur and provides a collision resolution algorithm to resolve collisions). In such a system, channel quality at the MAC layer is largely affected by the probability of packet loss due to two independent factors—packet collisions and channel impairments. A key challenge in estimating channel quality is to distinguish packet loss caused by channel impairments from that caused by collisions. More particularly, since both channel impairments (e.g., low Signal to Noise S/N ratio) and packet collisions contribute to poor QoS, both need to be appropriately controlled in order to control QoS. Therefore, a need exists for a method and apparatus for determining a quality measure of a channel within a communication system that identifies both the channel impairment and the packet collisions contribution to QoS.

### BRIEF DESCRIPTION OF THE DRAWINGS

FIG. 1 is a block diagram of a communication system in accordance with the preferred embodiment of the present invention.

FIG. 2 is a block diagram of a source station in accordance with the preferred embodiment of the present invention.

FIG. 3 illustrates packet loss and subsequent retransmission after a predetermined time-out period.

FIG. 4 illustrates the relationship between a channel quality factor and different estimates of a packet loss probability α.

FIG. 5 is a flow chart showing the steps necessary for estimating the channel quality factor for a channel with a quality undulating characteristic due to time-varying impairments.

FIG. 6 is a flow chart showing operation of a source station in accordance with the preferred embodiment of the present invention.

### DETAILED DESCRIPTION OF THE DRAWINGS

To address the above-mentioned need, a method and apparatus for monitoring a quality measure of a channel is provided herein. In accordance with the preferred embodiment of the present invention a bandwidth manager sets a target packet loss probability under the assumption that the channel is perfect. A real-time estimation of an effective probability of packet loss caused by collisions (referred to as load-specific packet loss probability) is then determined by filtering out statistics relating to packet loss probability that exceeds the target packet loss probability. The probability of packet loss caused by channel impairments (referred to as impairment-specific packet loss probability) is computed after the estimates of both the load-specific packet loss probability and an overall packet loss probability is estimated. The channel quality is then estimated in terms of the impairment-specific packet loss probability by considering the overhead due to retransmissions of lost packets caused by channel impairments.

The present invention encompasses a method for determining a quality measure of a channel in a communication system. The method comprises the steps of determining a packet loss probability due to packet collisions, determining a packet loss probability due to channel conditions, and estimating the quality measure for the channel based on both the packet loss probability due to packet collisions and the packet loss probability due to channel conditions.

The present invention additionally encompasses a method of determining a packet loss probability due to channel conditions. The method comprises the steps of sampling a number (w) of packets most recently consecutively transmitted and determining among the w sampled packets a number (d(n)) of packets that are lost at a time when a last of the w packets (n^{th} packet) is sampled. An overall packet loss probability (p(n)) is computed based on d(n) and w, and packet loss probability due to packet collisions (T(n)) is determined based on d(n) and w. Finally a packet loss probability due to channel conditions (α(n)) is determined based on the overall packet loss probability and the packet loss probability due to collisions.

The present invention additionally encompasses an apparatus comprising means for determining a packet loss probability due to packet collisions, means for determining a packet loss probability due to channel conditions, and means for estimating the quality measure for the channel based on both the packet loss probability due to packet collisions and the packet loss probability due to channel conditions.

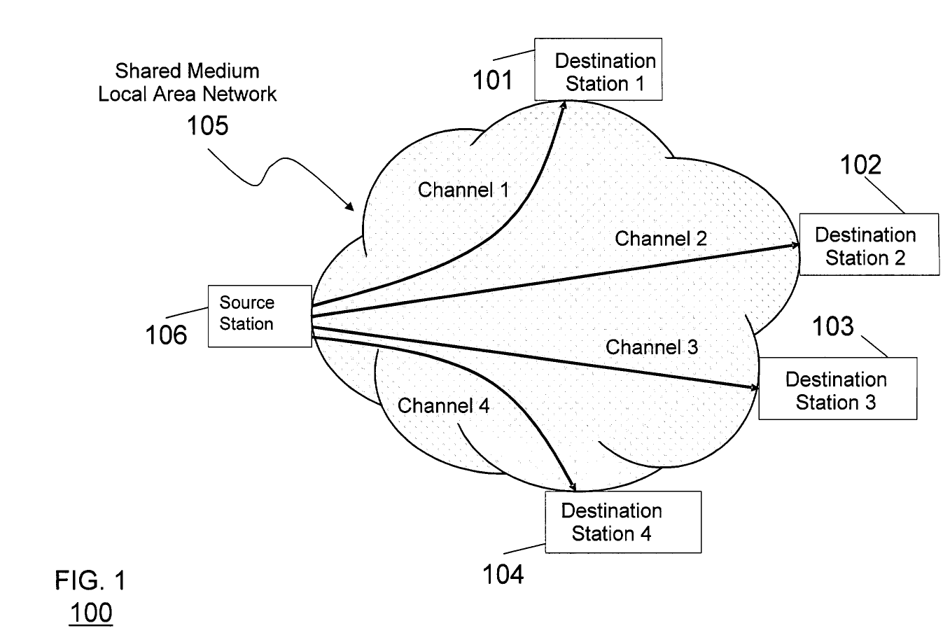

Turning now to the drawings, wherein like numerals designate like components, FIG. 1 is a block diagram of communication system 100 in accordance with the preferred embodiment of the present invention. Communication system 100 is a shared medium network that supports a population of geographically distributed stations 101-104. As shown, each station 101-104 is coupled to a source station 106's LAN port. Communication between source station 106 and stations 101-104 occur over local area network 105 via virtual channels. The quality of a channel depends not only on the physical conditions of the channel but also on the location of source 106 and destination stations 101-104. Each channel is associated with a source station 106 and one of the destination stations 101-104. For simplicity and without loss of generality, FIG. 1 shows single source station 106. Each channel between a source station and a destination station is referred to as an inter-nodal channel. Due to location dependency and time varying channel impairments, the packet loss probability and hence the effective link rate in the network may vary from channel to channel.

Let C denote a nominal link rate of an inter-nodal channel associated with a pair of source and destination stations in the multi-channel model, wherein the nominal link rate is a maximum throughput achievable by the source station at the link layer when the channel is idle provided there is no prevailing impairment in the channel at the physical (PHY) layer. Under normal operation in a contention-based system, the source station may achieve only a fraction of this nominal link rate because its channel shares a common physical medium with all other channels in the multi-channel system. In a Carrier Sense Multiple Access with Collision Avoidance (CSMA/CA) system, where transmissions may be involved in collisions and subsequently retransmitted, there is contention access overhead due to collision avoidance and collision resolution. Because of this, the MAC link quality at any of the destination stations 101-104 is a function of both a channel quality factor and collision rate. Thus, any communication system attempting to control QoS will preferably need to know both the channel quality factor and collision rate so that either may be adjusted to achieve a desired QoS.

In order to address this issue, a method and apparatus for determining the channel quality measure is provided below. In particular, the following discussion specifically focuses on channel quality monitoring at the Medium Access Control (MAC) layer for communication systems that employ a contention-based MAC. The probability of packet loss due to channel impairments is estimated and the channel quality factor from the MAC layer packet loss statistics is obtained. Prior to discussing the estimation of channel quality, a brief background about CSMA/CA type of LANs is provided.

CSMA/CA MAC Protocol:

Contention-based MAC protocols are known in the art. For example, a CSMA/CA protocol, which is a popular Ethernet and Ethernet-like LAN technologies is described in detail in R. M. Metcalf and D. R. Boggs, “Ethernet: Distributed packet switching for local computer networks,” Commun. ACM., vol. 19, no. 7, pp. 395-404, July 1976. This. basic protocol provides a foundation for numerous variations. Examples of CSMA/CA type MAC protocols include IEEE 802.11b wireless LANs operating in DCF (Distributed Coordination Function) mode, and HomePlug power line LANs.

In a CSMA/CA LAN, geographically distributed stations share a common communication channel, which may be a wireless channel or power line channel. Each station follows the same CSMA/CA protocol, which is a derivative of CSMA/CD. CSMA/CD stations determine the success of a transmitted packet by detecting if there is any collision, whereas CSMA/CA stations cannot detect collisions because of the physical media constraints. As a result, CSMA/CA based MAC protocols rely on immediate acknowledgement to monitor the status of the transmitted packet.

In the CSMA/CA MAC protocol, a station having MAC layer packets to send must first determine whether the medium is idle or busy by carrier sensing. If the medium is determined to be idle for a fixed amount of time, the station sends a MAC layer packet. If the medium is determined to be busy, the station will first wait until the medium becomes idle for the same fixed amount of time, and then carry out a random back off procedure after which the station will send the MAC layer packet. In the event of a collision, the protocol utilizes a Truncated Binary Exponential Back-off (TBEB) scheme for collision resolution. In this scheme, station involved in a collision waits a random number of slots, which is uniformly distributed within a window whose size that is an exponential function of the number of collisions the packet has experienced. After a predetermined maximum number of retransmissions, the MAC layer packet is discarded.

As CSMA/CA cannot rely on the capability of stations to detect collisions, every transmitted MAC layer packet requires a positive acknowledgment from the receiving station after a predetermined delay since the reception of the MAC layer packet by the station. If the sending station receives no acknowledgment within a time-out period, the MAC layer packet is considered lost, and the sending station retransmits the MAC layer packet after a random back-off period.

Like many shared medium networks, the throughput of CSMA/CA systems is a function of the offered load. As is known in the art, the throughput of IEEE 802.11b LANs (CSMA/CA based) increases with offered load when the offered load is light. As the offered load becomes high, the throughput gradually tapers off with further increase in offered load. The diminishing rate of increase in throughput with increasing offered load is largely due to increasing collisions. When there is a collision, packets involved in the collision are considered lost and must be retransmitted in accordance with a predetermined collision resolution algorithm. The throughput of the system can be maximized by properly configuring various system parameters, such as a retransmission probability.

Estimation of Channel Quality

If all inter-nodal channels in communication system 100 are assumed to be perfect, the throughput of a CSMA/CA type system is a function of the offered load. Additionally, the packet loss probability of a particular inter-nodal channel is also a function of the offered load under the same assumption. This packet loss probability is referred to as load-specific packet loss probability for a given offered load. Since the offered load varies in the system, the load-specific packet loss probability also varies. In the preferred embodiment of the present invention a bandwidth manager is introduced to source station 106 to control admission to the LAN such that the load-specific packet loss probability is bounded from above by a predetermined value, which is referred to as the target packet loss probability.

In reality, channels are not perfect in any networks. Even though we assume that packet loss due to factors other than collisions and channel impairments are negligible, it is necessary to ascertain the actual reason for a packet to be lost when such a loss is detected. The loss could be due to a collision, channel impairments, or both. Hence, to determine the portion of packet losses caused by the channel impairments from the overall packet loss statistics at the MAC layer is a challenging task.

To assess the overhead due to channel impairments, it is illuminating to consider an extreme scenario first, wherein the packet loss probability is assumed to be due to channel impairments only. Each packet that is lost is retransmitted, and it is assumed for the time being that retransmission is repeated for as many times as it is necessary for the packet to be successfully transmitted.

Let α denote the packet loss probability, wherein 0<α<1. Let v be the total number of transmissions for a given packet, including all retransmissions and the final successful transmission. Given v, the effective link rate of a channel will be the nominal link rate reduced by a factor 1/v for a positive integer v.

By the definition of α, a transmitted packet is lost with a probability α, and it is successfully transmitted with a probability (1−α). Assuming that α remains constant while the packet is retransmitted until there is a successful transmission, it is recognized that the packet transmission process is a random process characterized by a geometrically distributed random variable. Specifically, the probability that this random variable v takes on a value m is as follows.

Pr(v=m)=α^{(m-1)}(1−α) for m=1, 2, . . . (1)

It is straightforward to verify that

$$E ( 𝓋 ) = {\sum }_{m = 1}^{∞} m \cdot Pr ( 𝓋 = m ) = \frac{1}{1 - α} for 0 < α < 1 \qquad ( 2 )$$

where, there are on the average E(v)−1 retransmissions per successful transmission.

On the average, the effective link rate is reduced by E(1/v). In other words, the nominal link rate is reduced by a channel quality factor, σ(α), defined as follows.

$$σ ( α ) = E ( \frac{1}{𝓋} ) = {\sum }_{m = 1}^{∞} \frac{1}{m} Pr ( 𝓋 = m ) for 0 < α < 1 \qquad ( 3 )$$

The channel quality factor σ(α), provides a relative measurement of the current quality of the channel with respect to that of the channel under perfect conditions.

Since 1/v is a concave function of v, it can be verified that

$$σ ( α ) = E ( \frac{1}{𝓋} ) \geq \frac{1}{E ( 𝓋 )} = ( 1 - α ) for 0 < α < 1 \qquad ( 4 )$$

In practice, a packet may be retransmitted only up to a predetermined maximum number of times, after which the packet is discarded. Let u denote a predetermined upper bound on v. Then,

$${σ}^{′} ( α ) = E ( \frac{1}{𝓋} \vert 𝓋 \leq u ) = {\sum }_{m = 1}^{u} \frac{1}{m} Pr ( v = m \vert m \leq u ) \\ = \frac{{\sum }_{m = 1}^{u} \frac{1}{m} {α}^{( m - 1 )} ( 1 - α )}{{\sum }_{k = 1}^{u} {α}^{( k - 1 )} ( 1 - α )} for u \geq 1 , 0 < α < 1. \qquad ( 5 )$$

It can be verified that

$${σ}^{′} ( α ) = E ( \frac{1}{𝓋} \vert 𝓋 \leq u ) \geq \frac{1}{E ( 𝓋 \vert 𝓋 \leq u )} \geq \frac{1}{E ( 𝓋 )} = ( 1 - α ) for u \geq 1. \qquad ( 6 )$$

It follows that

σ′(α)≧σ(α)≧(1−α) for 0<α<1 (7)

In reality, packet loss is not caused by channel impairments only. Two independent random events contribute to packet loss—collisions and channel impairments. Thus, any estimate of a channel quality measure should take into consideration both types of packet losses. For example, providing an accurate quality measure may comprise simply providing the percentage of packet loss caused by channel conditions, along with providing the percentage of packet loss caused by collisions.

For a given offered load, T is denoted as the probability that a packet is lost due to collisions, i.e. the load-specific packet loss probability. As discussed above, α is the probability that a packet is lost due to channel impairments, referred to as impairment-specific packet loss probability. What is observed at the MAC layer is the combined effect of collisions and channel impairments. Since these two events are independent, the overall packet loss probability p is related to T and α as follows.

p=1−(1−T)(1−α)=T+α−Tα. (8)

By ignoring the higher order term Tα, p can be approximated as follows.

p=T+α. (9)

Thus, if the probability that a packet is lost due to collisions (T) and the overall packet loss probability p can be estimated, an estimate of α, can be made and thus an estimate for the channel quality factor σ′(α) can be obtained.

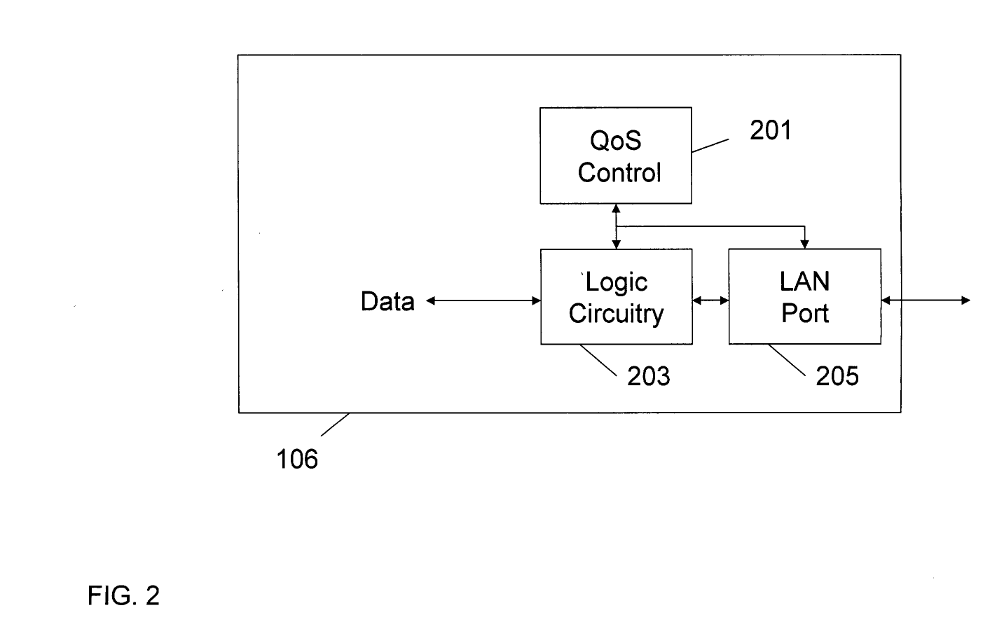

FIG. 2 is a block diagram of source station 106 in accordance with the preferred embodiment of the present invention. In the preferred embodiment of the present invention source station 106 comprises logic circuitry 203, QoS control circuitry 201, and LAN port 205. In the preferred embodiment of the present invention logic circuitry 203 is preferably a microprocessor controller, such as, but not limited to an enhanced 802.11b wireless LAN Network Interface Card (NIC) driver. QoS control circuitry 201 serves as means to control the quality of service for flows directed to any particular destination station. Such means includes, but is not limited to power control circuitry for increasing/decreasing transmit power, bandwidth allocation circuitry for increasing/decreasing channel bandwidth, and queue management circuitry for controlling selective discard of packets.

During operation, logic circuitry 203 monitors each inter-nodal channel independently. Logic circuitry serves as means for estimating the overall packet loss probability p. As discussed above, if the probability that a packet is lost due to collisions (T) and the overall packet loss probability p can be estimated, an estimate of the packet loss due to channel conditions (α), can be made. Thus, logic circuitry 203 will know both packet loss due to channel conditions and packet loss due to collisions. Once both T and a are known, QoS control circuitry 201 can appropriately control the QoS to a user by adjusting variables that control both channel quality and collision rate. For example, QoS controller 201 might schedule transmission of fewer packets on an inter-nodal channel that has poorer channel quality.

Estimation of Overall Packet Loss Probability

Logic circuitry 203 tracks packet transmission statistics in terms of the success or failure of each transmission. This is done via analysis of acknowledgment messages confirming successful receipt of the packet by the intended receiver. Should logic circuitry 203 receive no acknowledgment message after a time-out period, the packet is considered lost and retransmitted in accordance with a predetermined retransmission procedure.

Logic circuitry 203 serves as means for analyzing lost packets to determine an overall probability for packet loss p. More particularly, logic circuitry 203 samples a number (w) of most recently consecutively transmitted packets, and determines a number (d) of packets that are lost. Circuitry 203 then serves as a means for computing an estimate of the instantaneous overall packet loss probability (p) in terms of a ratio of d to w. If the overall packet loss probability were stationary, then this estimate would provide an unbiased estimation of the overall packet loss probability in the sense that it would converge to the actual overall packet loss probability as the sample size tends to infinity.

In reality, the overall packet loss probability may change from time to time. However, if it is assumed that the change is sufficiently slow to permit a simple tracking method to converge to an estimate of the overall packet loss probability, which is, more specifically, the overall packet loss probability that is currently effective.

In the preferred embodiment of the present invention each of a stream of packets transmitted by the station is identified by a sequence number n, wherein n≧1. Then p(n) is defined to be an estimate of the overall packet loss probability at the time when the last of the most recent w packets (n^{th} packet) is sampled, and d(n) the number of lost packets in the most recent window of w packets right before this time, wherein w>0.

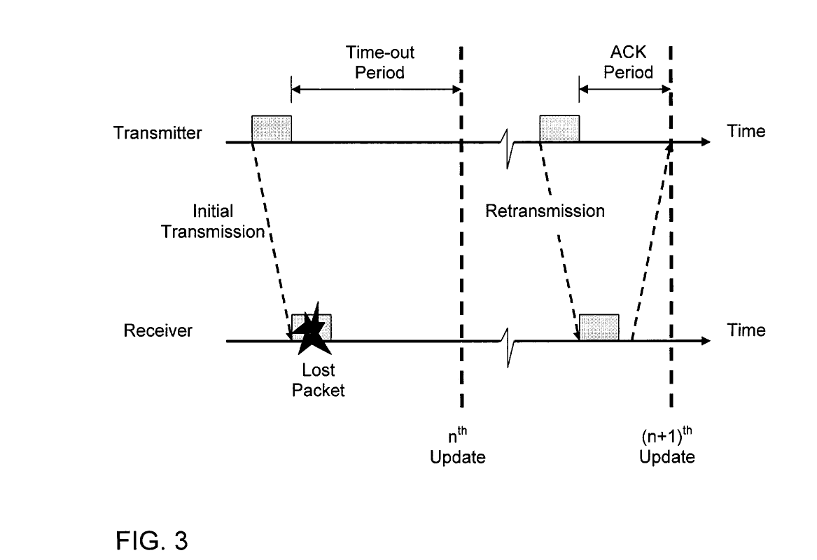

FIG. 3 illustrates an example where a packet is lost and for every retransmission of the same packet, both n and d(n) are increased by 1. At the same time, estimates of the load-specific packet loss probability T, the impairment-specific packet loss probability α as well as the channel quality factor are all updated accordingly. As shown in FIG. 3, the initial transmitted packet is considered lost by the transmitter after a time-out period. Following the CSMA/CA protocol, the transmitter keeps retransmitting the same packet after a random back-off period until the receiver successfully receives the packet and sends an Acknowledge packet to the transmitter. The transmitter considers the retransmission to be successful after receiving the Acknowledge packet.

In the preferred embodiment of the present invention well-known exponential smoothing method are used by logic circuitry 203 to estimate the overall packet loss probability. Thus,

$$p ( n ) = ( 1 - b ) p ( n - 1 ) + b \frac{d ( n )}{w} \leq 1 for n = 1 , 2 , … \qquad ( 10 )$$

where p(0)=0, d(1) is obtained from the first observation, and b is a smoothing parameter such that 0<b<1.

Estimation of Packet Loss Probability Due to Collision

As discussed above, the load-specific packet loss probability (i.e., of packet loss caused by collisions) is a function of the offered load, which may vary from time to time. Also it is assumed that the target loss probability is set by a bandwidth manager (e.g., QoS control 201). For example, the target packet loss probability can be implemented as part of an admission control policy that determines for each admission request whether the request is to be accepted. Such a target packet loss probability is denoted by T₀. In the preferred embodiment of the present invention the packet loss probability for packets transmitted by the source station (due to packet collisions) is estimated by logic circuitry 203 based on acknowledgment data received from the receive station.

If T(n) represent an estimate of T at the time when the n^{th} packet is sampled, for n=1, 2 . . . then in the preferred embodiment of the present invention the following method is utilized for estimating T.

$$T ( n ) = \{ \begin{matrix}( 1 - λ ) T ( n - 1 ) + λ \frac{d ( n )}{w} & for 0 \leq \frac{d ( n )}{w} < {T}_{0} \\ T ( n - 1 ) & otherwise \end{matrix} \qquad ( 11 )$$

where T(0)=T₀>0, d(1) is obtained from the first observation, and λ is a smoothing parameter such that 0<λ<1. In other words, the estimate for the load-specific packet loss probability is updated only when the estimate of the instantaneous overall packet loss probability is smaller than the target packet loss probability. In the preferred embodiment of the present invention logic circuitry 203 serves as means for estimating T(n).

Estimation of Channel Quality Factor

Once logic circuitry 203 has obtained estimates p(n) and T(n), it can estimate α(n), the impairment-specific packet loss probability at n^{th} sample, as follows.

$$α ( n ) = max ( \frac{p ( n ) - T ( n )}{1 - T ( n )} , 0 ) = \frac{max ( p ( n ) - T ( n ) , 0 )}{1 - T ( n )} \geq max ( p ( n ) - T ( n ) , 0 ) for n = 1 , 2 , \qquad ( 12 )$$

where p(n) and T(n) are obtained from (10) and (11) respectively. The introduction of the maximum operation in (12) is to ensure that the estimate α(n)≧0 even before the estimates of p(n) and T(n) converge to their respective steady-state values. When T(n)<<1, the following approximation can be used:

α(n)=max {p(n)−T(n), 0}≦1. (13)

Using (4) and (13), logic circuitry 203 obtains σ(n), an estimate of the channel quality factor at the time when the n^{th} packet is sampled, as follows.

σ(n)=1−α(n)≦1 for n=1, 2, . . . (14)

Note that the above estimate is a lower bound on the actual channel quality factor. A more accurate estimate of the channel quality factor is

$${σ}^{′} ( n ) = \frac{{\sum }_{m = 1}^{u} \frac{1}{m} {α ( n )}^{( m - 1 )} ( 1 - α ( n ) )}{{\sum }_{k = 1}^{u} {α ( n )}^{( k - 1 )} ( 1 - α ( n ) )} \geq σ ( n ) for u \geq 1 , 0 < α ( n ) < 1 \qquad ( 15 )$$

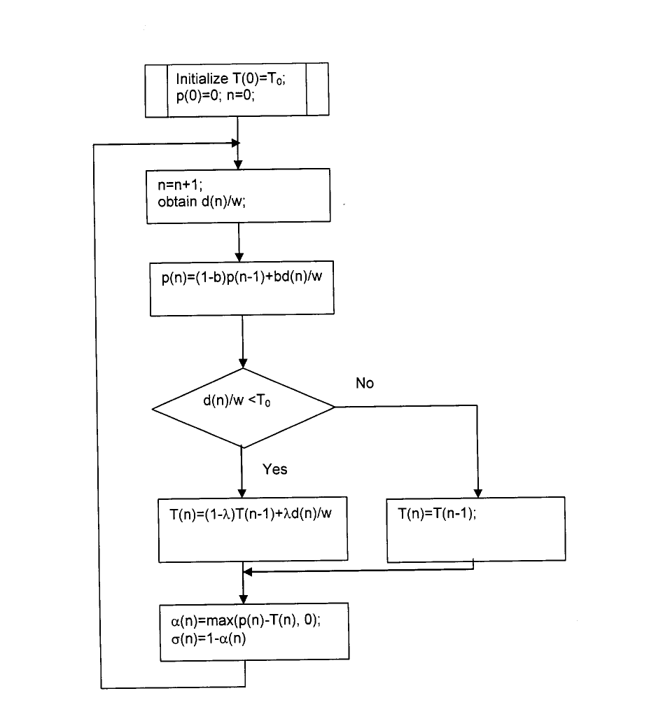

FIG. 4 illustrates the relationship between the channel quality factor and different estimates of α. Thus, once the channel quality factor is known, α can easily be obtained. The top curve shows σ′(n) versus α(n). The middle curve shows σ(n) versus α(n). The lower curve shows σ(n) versus p(n). It can be seen that σ(n) is indeed a lower bound of σ′(n). The main reason the lower bound σ(n) is utilized is that it involves subtraction only, and hence is simple to implement, especially for platforms using integer mode. It can also be seen that if the estimated overall packet loss probability p(n) is used to estimate σ(n), the impairment-specific packet loss probability would be overestimated by a factor of T(n). For CSMA/CA type of systems, T(n) could be significant.

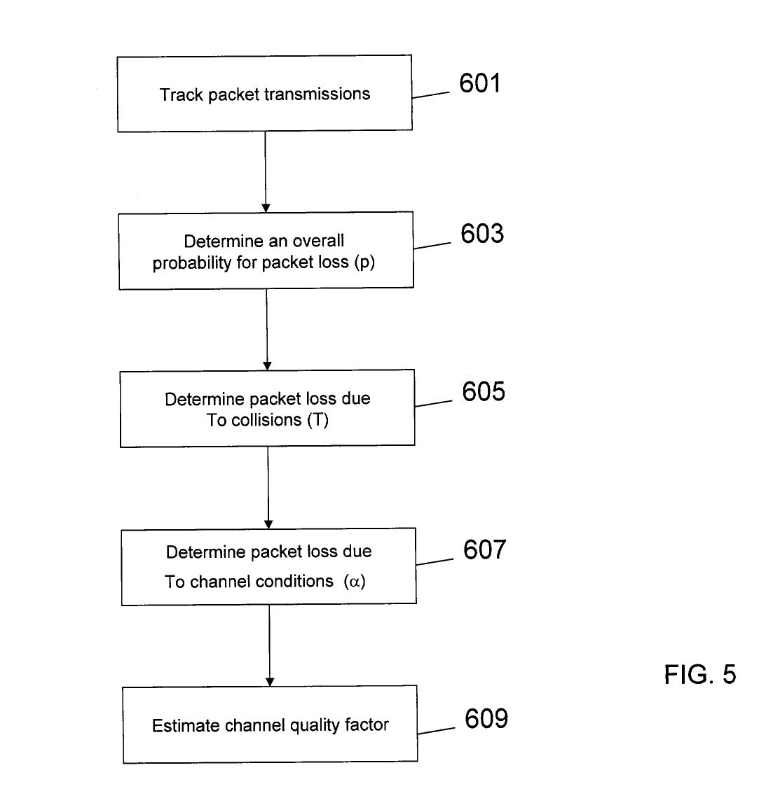

FIG. 5 is a flow chart showing the algorithm for estimating the quality factor for a channel with a quality undulating characteristic due to time-varying impairments. In the preferred embodiment of the present invention logic circuitry 203 serves as means for executing the following algorithm:

System Parameters:

w: Window size of observation of packet loss

b: Smoothing factor for the overall packet loss probability estimation

λ: Smoothing factor for the load-specific packet loss probability estimation

The Algorithm:

```
  For each active MAC address,
  T(0) = T₀, p(0) = 0;
for (n = 1;;n++)
{
obtain d(n)/w;
$p ( n ) = ( 1 - b ) p ( n - 1 ) + b \frac{d ( n )}{w} ;$
if (d(n)/w < T₀){
T(n) = (1 − λ)T(n − 1) + λd(n)/w;}
else
{
T(n) = T(n − 1);
}
α(n) = max(p(n) − T(n), 0);
```

σ(n) = 1 − σ(n);
}

As discussed above, one can also choose to estimate σ′(n) instead of σ(n) in the above algorithm at the price of increased complexity and implementation burdens.

FIG. 6 is a flow chart showing operation of source station 106 in accordance with the preferred embodiment of the present invention. In the preferred embodiment of the present invention the logic flow takes place within logic circuitry 203. The logic flow begins at step 601 where logic circuitry 203 serves as means for tracking packet transmission statistics in terms of the success or failure of each transmission. At step 603 an overall probability for packet loss (p) is determined by circuitry 203 based on the packet tracking. Next, at step 605, an estimate of the packet loss probability due to collision (T) is made by logic circuitry 203. As discussed above, this is specifically accomplished by utilizing equation (11) above. At step 607, the packet loss due to channel conditions (α) is determined. More particularly, since both p and T are known, and since p=T+α, α can easily be determined. Finally, at step 609, the QoS is appropriately adjusted for a particular user. As discussed above, since both the packet loss due to collisions, and the packet loss due to channel conditions are known, an appropriate quality measure that includes both types of packet losses can be made and QoS can be better controlled. This may be accomplished in several ways, including, but not limited to varying packet transmission scheduling, varying data flow admission control, or varying channel transmission parameters (e.g., power).

While the invention has been particularly shown and described with reference to a particular embodiment, it will be understood by those skilled in the art that various changes in form and details may be made therein without departing from the spirit and scope of the invention. For example, the above discussion provides a method and apparatus for determining a packet loss probability due to channel conditions and the packet loss probability due to packet collisions. From this information a quality measure is provided that contains this information. In the preferred embodiment of the present invention this quality measure is simply a percentage of packet loss caused by both collisions and channel conditions, however one of ordinary skill in the art will recognize that any quality measure that utilizes the above determinations can be implemented without varying from the scope of the invention. It is intended that such changes come within the scope of the following claims.

1. A method for determining a quality measure of a channel in a communication system, the method comprising the steps of:
determining a packet loss probability due to packet collisions;
determining a packet loss probability due to channel conditions; and
estimating the quality measure for the channel based on both the packet loss probability due to packet collisions and the packet loss probability due to channel conditions.

2. The method of claim 1 wherein the step of determining the packet loss probabilities comprises the step of determining, by a source station, the packet loss probabilities of packets transmitted by the source station.

3. The method of claim 1 wherein the step of determining the packet loss probabilities comprises the step of determining, by a source station, the packet loss probabilities of packets transmitted by the source station to a remote station and based on acknowledgments received from the remote station.

4. The method of claim 1 further comprising the step of:
adjusting a Quality of Service of the communication system based on the estimated quality measure of the channel in the communication system.

5. The method of claim 1 wherein the step of determining the packet loss probabilities comprises the step of determining packet loss probabilities at a medium access control (MAC) layer.

6. The method of claim 1 wherein the step of determining the packet loss probability due to packet collisions comprises the steps of:
estimating an instantaneous packet loss probability;
determining a target packet loss probability based on a predetermined admission control policy; and
determining the packet loss probability due to packet collisions based on the instantaneous packet loss probability and the target packet loss probability.

7. The method of claim 6 wherein the step of determining the instantaneous packet loss probabilities comprises:
sampling a predetermined number (w) of most recently consecutively transmitted packets;
determining a number (d) of packets that are lost; and
determining the instantaneous packet loss probability by taking a ratio of d to w.

8. The method of claim 1 wherein the step of determining the packet loss probability due to channel conditions comprises the steps of:
determining an overall packet loss probability; and
determining the packet loss probability due to channel conditions based on the overall packet loss probability and the packet loss probability due to packet collisions.

9. A method of determining a packet loss probability due to channel conditions, the method comprising the steps of:
sampling a number (w) of packets most recently consecutively transmitted;
determining among the w sampled packets a number (d(n)) of packets that are lost at a time when a last of the w packets (n^{th} packet) is sampled;
computing an overall packet loss probability (p(n)) based on d(n) and w;
determining a packet loss probability due to packet collisions (T(n)) based on d(n) and w; and
determining a packet loss probability due to channel conditions (α(n)) based on the overall packet loss probability and the packet loss probability due to collisions.

10. The method of claim 9 wherein the step of computing the overall packet loss probability (p(n)) comprises the step of computing
$$p ( n ) = ( 1 - b ) p ( n - 1 ) + b \frac{d ( n )}{w} ,$$
wherein b is a smoothing factor for the overall packet loss probability estimation, and p(n−1) is a previous estimate of the overall packet loss probability.

11. The method of claim 9 wherein the step of determining the packet loss probability due to collisions (T(n)) comprises the step of computing T(n)=(1−λ) T(n−1)+λ d(n)/w if (d(n)/w<T₀) otherwise computing T(n)=T(n−1), wherein T(n−1) is a previous estimate of a packet loss probability due to collisions, T₀ is a target packet loss probability, and λ is a smoothing factor for the estimation of the packet loss probability due to packet collisions.

12. The method of claim 9 wherein the step of determining packet loss probability due to channel conditions (α(n)) comprises the step of determining α(n)=max((p(n)−T(n))/(1−T(n)),0).

13. The method of claim 9 wherein the step of determining the packet loss probability due to channel conditions (α(n)) comprises the step of determining α(n)=max(p(n)−T(n),0).

14. An apparatus in a communication system comprising:
means for determining a packet loss probability due to packet collisions;
means for determining a packet loss probability due to channel conditions; and
means for estimating the quality measure for the channel based on both the packet loss probability due to packet collisions and the packet loss probability due to channel conditions.

15. The apparatus of claim 14 wherein the means for determining the packet loss probabilities comprises means for determining, by a source station, the packet loss probabilities of packets transmitted by the source station.

16. The apparatus of claim 14 wherein the means for determining the packet loss probabilities comprises means for determining, by a source station, the packet loss probabilities of packets transmitted by the source station to a remote station and based on acknowledgments received from the remote station.

17. The apparatus of claim 14 further comprising means for adjusting a Quality of Service of the communication system based on the estimated quality measure for the channel in the communication system.

18. The apparatus of claim 14 wherein the means for determining the packet loss probabilities comprises means for determining packet loss probabilities at a medium access control (MAC) layer.

19. The apparatus of claim 14 wherein the means for determining the packet loss probability due to packet collisions comprises:
means for estimating an instantaneous packet loss probability;
means for determining a target packet loss probability based on a predetermined admission control policy; and
means for determining the packet loss probability due to packet collisions based on the instantaneous packet loss probability and the target packet loss probability.

20. The apparatus of claim 14 wherein the means for determining the packet loss probability due to channel conditions comprises means for determining an overall packet loss probability and determining the packet loss probability due to channel conditions based on the overall packet loss probability and the packet loss probability due to packet collisions.
